(19) United States
(12) Patent Application Publication
(10) Pub. No.: US 2025/0262893 A1
(43) Pub. Date: Aug. 21, 2025

(54) REMOVABLE WHEEL ASSEMBLY AND METHOD

(71) Applicant: Honda Motor Co., Ltd., Tokyo (JP)

(72) Inventors: Jeremy N. ROLON, Redondo Beach, CA (US); Robert Antonio RANGEL, Huntington Beach, CA (US); Robert F. CURIEL, Corona, CA (US); Geemay CHIA, Pasadena, CA (US); Dillon KANE, Los Angeles, CA (US)

(21) Appl. No.: 18/442,819

(22) Filed: Feb. 15, 2024

(51) Int. Cl. B60B 35/00; B60B 1/00; B60B 35/04; B60B 37/04; B62B 5/06

(52) U.S. Cl. CPC B60B 35/004; B60B 35/04; B60B 37/04; B60B 1/00; B62B 5/06; B62B 2301/05

(57) ABSTRACT

A removable wheel assembly and method includes a wheel hub and an axle shaft fixedly secured to the wheel hub at a proximal end and having a circumferential groove defined therein. The wheel assembly also includes a wheel rim radially spaced apart from and concentric with the wheel hub, and a locking device having an engagement end that is radially received within the circumferential groove of the axle shaft for inhibiting axial movement of the axle shaft and thereby inhibiting axial movement of the wheel hub.

### BACKGROUND

A variety of removable wheel systems are known. For example, an axle can be provided that extends across an entirety of a body (for example, a carrying platform) and has wheels axially secured to each end of the axle by cotter pins or some other retaining clip. One specific example of this configuration is found in hand trucks or dollies in which a flat or plate-like base member is provided and has an axle rotatably affixed thereto. The axle extends across an entirety of the base member with wheels secured at either end. An upright support structure is provided orthogonal to the base member for manipulating a load carried by the base member and optionally for providing a secondary support for the load. In another example, an axle shaft is provided with a circumferential groove at an end thereof and a corresponding locking pin is configured to insert into the groove to lock a wheel to the axle shaft. In particular, the locking pin is spring loaded and movably fixed to the removable wheel.

### BRIEF DESCRIPTION

According to one aspect, a wheel assembly includes a wheel hub and an axle shaft fixedly secured to the wheel hub at a proximal end thereof and having a circumferential groove defined therein. The wheel assembly also includes a wheel rim radially spaced apart from and concentric with the wheel hub, and a locking device having an engagement end that is radially received within the circumferential groove of the axle shaft for inhibiting axial movement of the axle shaft and thereby inhibiting axial movement of the wheel hub.

According to another aspect, a removable wheel assembly for a carrier body includes a wheel hub having a wheel rim radially disposed thereabout and a short axle shaft fixedly secured to the wheel hub. The short axle shaft defines a circumferential groove that is spaced apart from the wheel hub. The removable wheel assembly further includes a locking device having an engagement end radially receivable in the circumferential groove of the short axle shaft for locking the short axle shaft within an axle bore of the carrier body.

According to a further aspect, a removable wheel method includes provision of a wheel hub with an axle shaft fixedly secured to the wheel hub at a proximal end thereof. The axle shaft has a circumferential groove defined therein. The wheel hub supports a wheel rim in radially spaced relation relative to the wheel hub and the axle. The method further includes insertion of the axle shaft into an axle bore defined in a carrier body and insertion of a locking device into the carrier body such that an engagement end of the locking device is radially received in the circumferential groove of the axle shaft to inhibit axial movement of the axial shaft thereby preventing removal of the wheel hub from the carrier body.

### BRIEF DESCRIPTION OF DRAWINGS

FIG. 1 is a perspective view of a carrier assembly having a pair of removable wheel assemblies thereon in accord with an exemplary embodiment;

FIG. 2 is an exploded perspective view of the carrier assembly of FIG. 1.

FIG. 3 is a partial enlarged view of one of the removable wheel assemblies of claim 1 shown secured to a carrier body of the carrier assembly of FIG. 1.

FIG. 4 is a partial englarged perspective view of an underside of the carrier body shown with a locking device removed therefrom.

FIG. 5 is a block diagram illustrating a removable wheel method in accord with an exemplary embodiment.

### DETAILED DESCRIPTION OF THE INVENTION

It should, of course, be understood that the description and drawings herein are merely illustrative and that various modifications and changes can be made in the structures disclosed without departing from the present disclosure. Spatially relative terms may be used to describe an element and/or features relationship to another element(s) and/or feature(s) as, for example, illustrated in the figures. Moreover, any term of degree used herein, such as “substantially” and “approximately” means a reasonable amount of deviation of the modified word is contemplated such that the end result is not significantly changed.

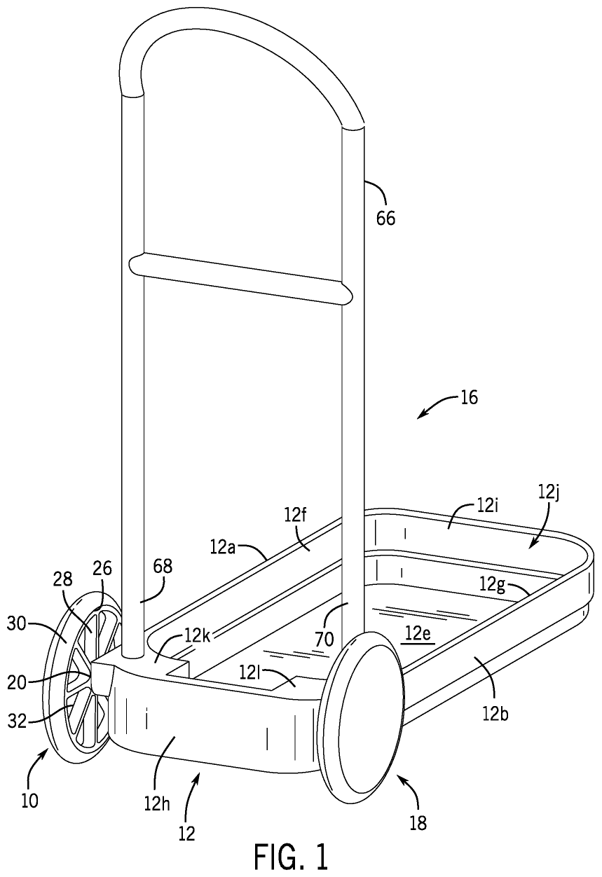

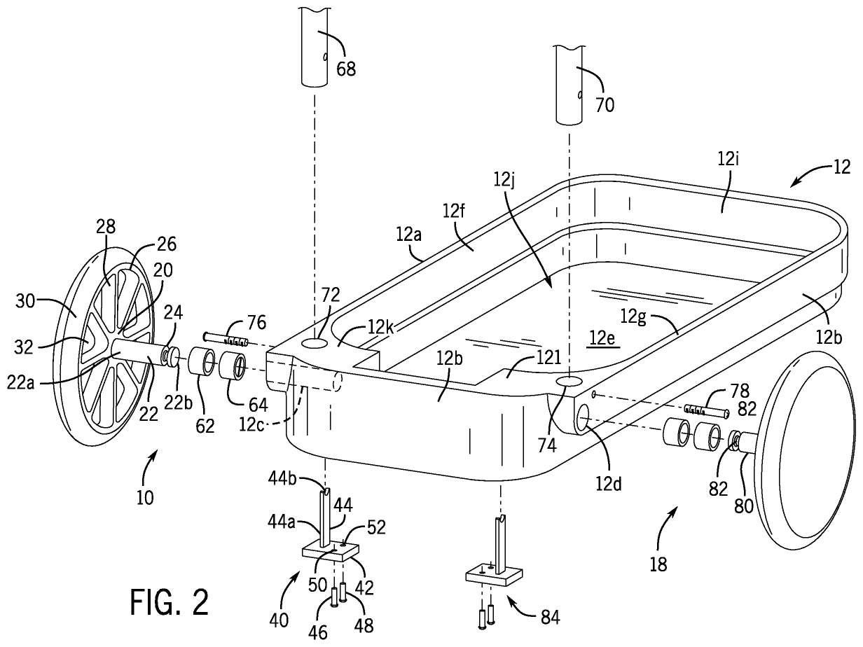

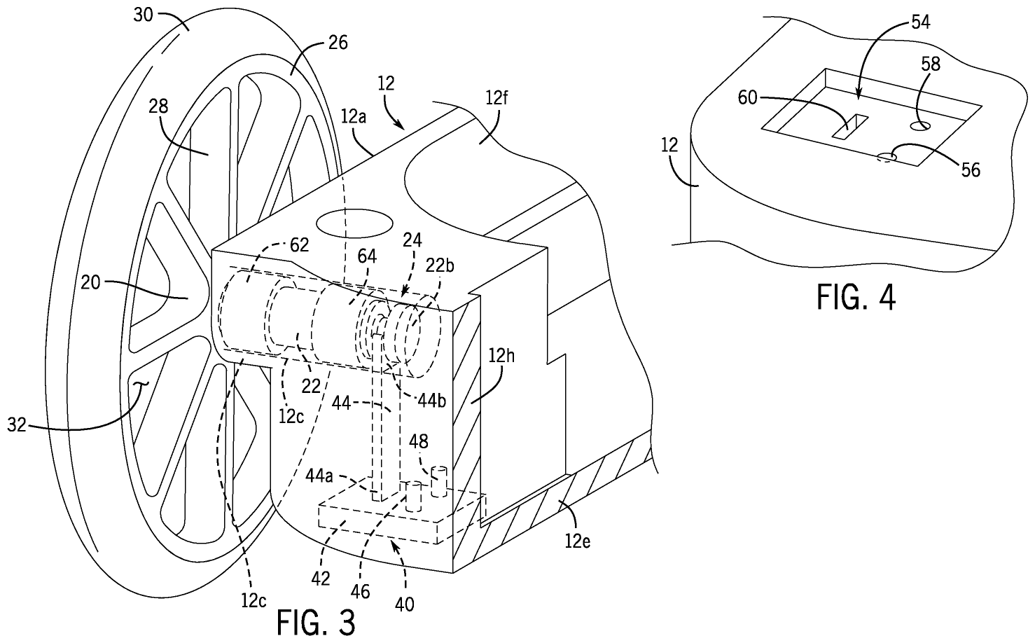

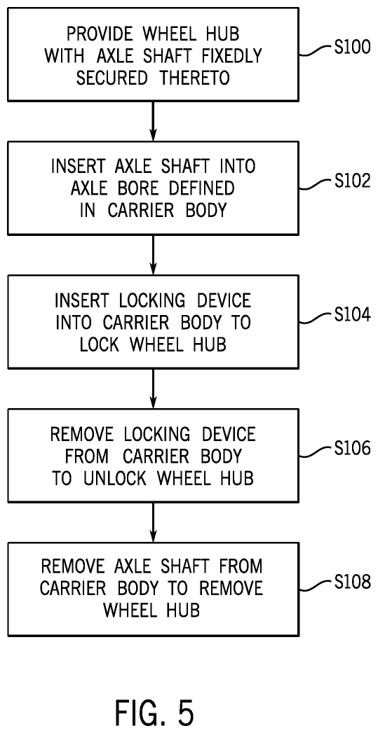

Referring now to the drawings, wherein like numerals refer to like parts throughout the several views, FIGS. 1-3 illustrates a removable wheel assembly 10 for a carrier body 12 according to one embodiment of the present disclosure. In the illustrated embodiment, the carrier body 12 can be the base of a carrier assembly 16. In one embodiment, the carrier assembly 16 is a hand truck or dolly of the type used to carry loads on the carrier body 12. However, it is to be appreciated by those skilled in the art that the carrier body 12 could be any carrier body associated with a variety of assemblies, including for example a dolly, a cart, etc., and need not be configured as a hand truck as shown in the illustrated embodiment.

Also, the removable wheel assembly 10 is one of two removable wheel assemblies 10, 18 in the illustrated embodiment in that the wheel assembly 10 is provided on a first side 12a of the carrier body 12 and the wheel assembly 18 is provided on a second side 12b of the carrier body 12 that is opposite the first side 12a. As shown, the wheel assemblies 10, 18 can be identical to one another and so only wheel assembly 10 will be described in further detail herein, though it is to be appreciated that all details discussed in reference to wheel assembly 10 are applicable to the wheel assembly 18.

More particularly, the wheel assembly 10 includes a wheel hub 20 and an axle shaft 22 fixedly secured to the wheel hub 20 at a proximal end 22a thereof. In particular, the axle shaft 22 can be welded to the wheel hub 20. Alternatively, the axle shaft 22 can be co-molded with the wheel hub 20 or otherwise integrally formed with the wheel hub 20 so as to comprise a unitary component. The axle shaft 22 of the illustrated embodiment is a short axle shaft 22 that has a circumferential groove 24 defined therein that is spaced apart from the wheel hub 20. In particular, in the illustrated embodiment, the circumferential groove 24 is defined in the axle shaft 22 at or adjacent a distal end 22b of the axle shaft 22 (i.e., the distal end 22b is distal relative to the wheel hub 20). The wheel assembly 10 also includes a wheel rim 26 radially spaced apart from and concentric with the wheel hub 20. More specifically, the wheel hub 20 has the wheel rim 26 radially disposed thereabout. Spokes 28 can extend radially between the wheel hub 20 and the wheel rim 26, and a tire 30 can be annularly disposed on the wheel rim 26. In the illustrated embodiment, a cover member is disposed axially on one side of the spokes 28, thought this is not required.

The wheel assembly 10 further includes a locking device 40 for selectively locking both the wheel hub 20 and the axle shaft 22, which is fixedly secured to the wheel hub 20, to the carrier body 12. In particular, the locking device 40 includes a base portion or locking plate 42 and a shaft portion or extension arm 44. The shaft portion 44 has a proximal end 44a fixed to the base portion 42 and an engagement end 44b disposed distally relative to the base portion 42. The engagement end 44b can be radially received within the circumferential groove 24 of the axle shaft 22 for inhibiting axial movement of the axle shaft 22 and thereby inhibiting axial movement of the wheel hub 20 relative to the carrier body 12. In other words, the locking device 40 has the engagement end 34b that is radially receivable in the circumferential groove 24 of the axle shaft 22 for locking the axle shaft 22 within a first axle bore 12c of the carrier body 12. In the illustrated embodiment, the engagement end 44b can be complementarily formed in a semi-circular shape so as to substantially match and correspond with the portion of the axle shaft 22 defining the circumferential groove 24.

The wheel assembly 10 can also include threaded members 46, 48 received in corresponding throughholes 50, 52 defined in the base portion 42 to secure the base portion 42 to an associated body (e.g., the carrier body 12 in the illustrated embodiment) and thereby axially secure the axle shaft 22 to the carrier body 12. More particularly, in the illustrated embodiment, the throughholes 50, 52 are spaced apart from the shaft portion 44. With additional reference to FIG. 4, the carrier body 12 can include a recessed portion 54 in which the base portion 42 can be accommodated so as to present a flush or near flush appearance. The carrier body 12 can also include threaded bores 56, 58 into which the threaded members 46, 48 are threadedly received to removably secure the locking device 40 to the carrier body 12.

In a locked state, the shaft portion 44 extends through a locking slot 60 defined in the carrier body 12 and connected to the first axle bore 12c to extend into the circumferential groove 24 of the axle shaft 22 to lock the axle shaft 22 in the carrier body 12. In an unlocked state, the shaft portion 44 is removed from the locking slot 60 to allow for removable of the axle shaft 22 from the carrier body 12. Also in the locked state, the base portion 42 is lockable to the carrier body 12 to lock the shaft portion 44 in the locking slot 60 and to lock the engagement end 34b in the circumferential groove 24 to hereby lock the axle shaft 22 in the carrier body 12.

The wheel assembly 10 can additionally include at least one annular bearing, and in the illustrated embodiment includes a pair of annular bearings 62, 64 that are annularly disposed on the axle shaft 22. In particular, in the illustrated embodiment, the at least one annular bearing can include first annual bearing 62 axially spaced form the wheel hub 20 and a second annular bearing 64 axially spaced apart from the wheel hub 20 and from the first annular bearing 62. The annular bearings 62, 64 can facilitate rotation of the axle shaft 22 and thereby the wheel hub 20 relative to the carrier body 12.

As discussed above, the carrier body 12 defines the axle bore 12c in the first side 12a into which the axle shaft 22 is receivable. The annular bearings 62, 64 are annularly disposed on the axle shaft 22 and radially disposed between the axle shaft 22 and a portion of the carrier body 12 defining the axle bore 12c. As shown, the first axle bore 12c can extend only partially into the carrier body 12. That is, the first axle bore 12c can have an axial dimension that is less than a width dimension between the first and second sides 12a, 12b of the carrier body 12. In particular, the first axle bore 12c can have an axial dimension that is short relative to the width dimension of the carrier body 12 and corresponds to the axial length of the axle shaft 22 allowing the axle shaft 22 to be a short axle shaft 22. A second axial bore 12d can be provided in the second side 12b for accommodating the second wheel assembly 18 and can be a mirror image of the first axial bore 12c.

In one example, the axial length of the axle shaft 22 and the first axle bore 12c can be less than half the width dimension of the carrier body. In a more particular example, the axial length of the axle shaft 22 and the first axle bore 12c can be less than one third the width of the carrier body 12. This is advantageous in that the carrier body 12 be sized and shaped to accommodate the shorter axial dimension of the axial bore 12c thereby providing increased carrying capacity within the carrier body 12.

More particularly, in the illustrated embodiment, the carrier body 12 can include a base portion or wall 12e having sidewalls 12f, 12g, 12h and 12i extending orthogonally upward therefrom. In particular, the sidewall 12f can extend upward to form the first side 12a and the sidewall 12g can extend upward opposite the sidewall 12f to form the second side 12b. The sidewalls 12h and 12i can extend between and connect to the sidewalls 12f and 12g. The sidewalls 12f, 12g, 12h, 12i together can form a cargo or receptable area 12j in which associated items can be loaded, carried by the carrier body 12 and later unloaded. The recessed portion 54 is particularly disposed on an underside of the base portion or wall 12e as best shown in FIG. 4.

Where the sidewall 12h meets with the sidewalls 12f and 12g, respectively, corner portions 12k, 12l can be provided with increased dimensions and size for accommodating the axial bores 12c, 12d. These corner portions 12k, 12l can extend partially into the cargo area 12j thereby reducing an overall volume available in the cargo area 12j. Accordingly, having these corner portions 12k, 12l reduced in size (i.e., they do not extend across the carrier body 12) is advantageous in that more volume can be provided in the cargo area 12j. Thus, the shorter axial dimension of the axle shaft 22 and thereby the shorter required axial dimension for the axle bore 12c advantageously increases the cargo volume available by the carrier body 12.

In the illustrated embodiment, an upright handle member 66 can extend upward from the carrier body 12 for manual manipulation of the carrier body 12. IN particular, the upright handle member 66 can include legs 68, 70 receivable in handle bores 72, 74 defined in or near the corner portions 12k, 12l of the carrier body and secured to the carrier body 12 via fasteners 76, 78, such as threaded fasteners or bolts. Of course, other handle members could be used instead of handle member 66 and/or other connects between the handle member 66 and the legs 68, 70 could be provided. By the illustrated arrangement, the carrier body 12 can be manipulated together with the wheel assemblies 10, 18 to provide a hand truck assembly. Of course, it is to be appreciated that the carrier body 12 need not be configured as shown in the illustrated embodiment and/or the upright handle member 66 need not be provided or, as already mentioned, could be alternatively provided.

As mentioned, the wheel hub 20 and the axle shaft 22 correspond to the first wheel assembly 10 and are thus a first wheel hub 20 and a first axle shaft 22. The second wheel assembly 18 can likewise include a second wheel hub (not shown) and a second axle shaft 80 fixedly secured to the second wheel hub at a proximal end thereof and having a second axle circumferential groove 82 defined therein. A second locking device 84 can be provided for selectively locking the second wheel assembly 18 to the carrier body 12. When both wheel assemblies 10, 18 are locked to the carrier body 12, as shown in FIG. 1, the first and second axle shafts 22, 60 can be coaxial and axially spaced apart from one another.

Both wheel assemblies 10, 18 are easily removable from the carrier body 12 by removing the threaded members (e.g., threaded members 46, 48) and then removing the locking devices (e.g., locking device 40). Once the locking devices are removed, the axles 22, 80 can be removed from their respective bores 12c, 12d. Optionally, the wheel assemblies 10, 18 can be interchangeable with different types of wheels depending on the intended use. For example, larger wheels could be installed, such as for sand and/or softer surfaces; smaller, harder wheels can be used for smooth surfaces, pneumatic wheels could be used; hard rubber wheels could be used, scooter tires could be used, etc. Optionally, the wheel assemblies 10, 18 can be removed and the carrier body 12 used without any wheels.

A removable wheel method will now be described with reference to FIG. 4. In particular, the method will be described with respect to the wheel assembly 10 described herein but this is not required and the method could be used with other wheel assemblies. In the method, at S100, wheel hub 20 with axle shaft 22 fixedly secured to the wheel hub 20 at the proximal end 22a thereof is provided. As discussed hereinabove, the axle shaft 22 has the circumferential groove 24 defined herein and the wheel hub 20 supports the wheel rim 26 in radially spaced relation relative to the wheel hub 20 and the axle 22. At S102, the axle shaft 22 is inserted into the axle bore 12c defined in the carrier body 12. At S104, the locking device 40 is inserted into the carrier body 12 such that the engagement end 44b of the locking device 40 is radially received in the circumferential groove 24 of the axle shaft 22 to inhibit axial movement of the axial shaft 22 thereby preventing removable of the wheel hub 20 from the carrier body 12.

When desired to remove the wheel assembly 10, the method can continue at S106 wherein the locking device 40 is removed from the carrier body 12 to remove the engagement end 34b from the circumferential groove 24 to unlock the wheel hub 20 from the carrier body 12. Then, at S108, the axle shaft 22 can be removed from the axle bore 12c defined in the carrier body 12 to remove the wheel hub 20 and the wheel rim 26 from the carrier body 12. If desired, a different wheel assembly (e.g., one with differently sized and/or configured tires) can be installed on the carrier body 12.

It will be appreciated that various of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

1. A wheel assembly, comprising:
a wheel hub;
an axle shaft fixedly secured to the wheel hub at a proximal end thereof and having a circumferential groove defined therein;
a wheel rim radially spaced apart from and concentric with the wheel hub; and
a locking device having an engagement end that is radially received within the circumferential groove of the axle shaft for inhibiting axial movement of the axle shaft and thereby inhibiting axial movement of the wheel hub.

2. The wheel assembly of claim 1 wherein the circumferential groove is defined in the axle shaft adjacent a distal end of the axle shaft.

3. The wheel assembly of claim 1 wherein the locking device includes a base portion and a shaft portion, the shaft portion having a proximal end fixed to the base portion and having the engagement end disposed distally relative to the base portion.

4. The wheel assembly of claim 3 further including threaded members received in throughholes defined in the base portion to secure the base portion to an associated body and thereby axially secure the axle shaft to the associated body.

5. The wheel assembly of claim 1 further including at least one annular bearing annularly disposed on the axle shaft.

6. The wheel assembly of claim 5 wherein the at least one annular bearing includes a first annular bearing axially spaced from the wheel hub and a second annular bearing axially spaced from the wheel hub and from the first annular bearing.

7. The wheel assembly of claim 1 further including a carrier body defining an axle bore in a sidewall thereof into which the axle shaft is receivable.

8. The wheel assembly of claim 7 further including at least one annular bearing annularly disposed on the axle shaft and radially disposed between the axle shaft and a portion of the carrier body defining the axle bore.

9. The wheel assembly of claim 7 wherein the axle shaft is a short axle shaft extending only partially into the axle bore of the carrier body.

10. The wheel assembly of claim 7 further including an upright handle member extending upward from the carrier body for manual manipulation of the carrier body.

11. The wheel assembly of claim 1 wherein the wheel hub and the axle shaft are, respectively, a first wheel hub and a first axle shaft, wherein the wheel assembly further includes a second wheel hub and a second axle shaft fixedly secured to the second wheel hub at a proximal end thereof and having a second axle circumferential groove defined therein, wherein the first and second axle shafts are coaxial and axially spaced apart from one another.

12. The wheel assembly of claim 1 wherein the axle shaft is welded to the wheel hub.

13. The wheel assembly of claim 1 further including spokes extending radially between the wheel hub and the wheel rim, and a tire annularly disposed on the wheel rim.

14. A removable wheel assembly for a carrier body, comprising:
a wheel hub having a wheel rim radially disposed thereabout;
a short axle shaft fixedly secured to the wheel hub, the short axle shaft defining a circumferential groove that is spaced apart from the wheel hub; and
a locking device having an engagement end radially receivable in the circumferential groove of the short axle shaft for locking the short axle shaft within an axle bore of the carrier body.

15. The removable wheel assembly of claim 14 wherein the axle bore extends only partially into the carrier body.

16. The removable wheel assembly of claim 15 wherein the locking device includes an extension arm having the engagement end disposed at one end thereof, wherein, in a locked state, the extension arm extends through a locking slot defined in the carrier body and connected to the axle bore to extend into the circumferential groove of the short axle shaft to lock the short axle shaft in the carrier body, and, in an unlocked state, the extension arm is removed from the locking slot to allow removal of the short axle shaft from the carrier body.

17. The removable wheel assembly of claim 16 wherein the locking device further includes a locking plate disposed at another end that is opposite said one end, the locking plate lockable to the carrier body to lock the extension arm in the locking slot and to lock the engagement end in the circumferential groove to thereby lock the short axle shaft in the carrier body.

18. The removable wheel assembly of claim 17 wherein the locking plate includes at least two throughholes that receive threaded fasteners to lock the locking plate to the carrier body.

19. A removable wheel method, comprising:
providing a wheel hub with an axle shaft fixedly secured to the wheel hub at a proximal end thereof, the axle shaft having a circumferential groove defined therein, the wheel hub supporting a wheel rim in radially spaced relation relative to the wheel hub and the axle;
inserting the axle shaft into an axle bore defined in a carrier body; and
inserting a locking device into the carrier body such that an engagement end of the locking device is radially received in the circumferential groove of the axle shaft to inhibit axial movement of the axle shaft thereby preventing removal of the wheel hub from the carrier body.

20. The removable wheel method of claim 19, further including:
removing the locking device from the carrier body to remove the engagement end from the circumferential groove to unlock the wheel hub from the carrier body; and
removing the axle shaft from the bore defined in the carrier body to remove the wheel hub and wheel rim from the carrier body.
